(19) United States
(12) Patent Application Publication
(10) Pub. No.: US 2023/0182472 A1
(43) Pub. Date: Jun. 15, 2023

(54) LIQUID DISCHARGE APPARATUS, LIQUID DISCHARGER, AND METHOD FOR DRIVING LIQUID DISCHARGE HEAD

(71) Applicant: Satoshi KITAOKA, Kanagawa (JP)

(72) Inventor: Satoshi KITAOKA, Kanagawa (JP)

(21) Appl. No.: 17/925,825

(22) PCT Filed: Jul. 13, 2021
(86) PCT No.: PCT/IB2021/056264

§ 371 Date: Nov. 17, 2022

(30) Foreign Application Priority Data
Jul. 31, 2020 (JP) 2020-130178
Apr. 23, 2021 (JP) 2021-073082

(51) Int. Cl. B41J 2/165; B41J 25/304

(52) U.S. Cl. CPC B41J 2/16535; B41J 25/304

(57) ABSTRACT

A liquid discharge apparatus includes a carriage (1), a liquid discharge head (300, 300C, 300K, 300M, 300Y, 300S, 300W) having a discharge port (P1, P2), a first driver (92), and a second driver (93). The carriage is movable along at least one of a first axis (X) and a second axis (Y) intersecting the first axis. The liquid discharge head is held by the carriage and discharges a liquid from the discharge port toward an object (100) in a direction along a third axis (Z) intersecting the first axis and the second axis. The first driver moves the carriage along the third axis. The second driver moves the liquid discharge head along the third axis relative to the carriage.

### TECHNICAL FIELD

Embodiments of the present disclosure relate to a liquid discharge apparatus, a liquid discharger, and a method for driving a liquid discharge head.

### BACKGROUND ART

PTL 1 discloses an automatic drawing apparatus that includes a spray gun head unit, an X-direction driver, a Y-direction driver, and a Z-direction driver. The spray gun head unit holds a plurality of spray gun heads that is movable along a Z-axis. The X-direction driver drives the spray gun head unit along a horizontal X-axis. The Y-direction driver drives the spray gun head unit along a vertical Y-axis. The Z-axis is perpendicular to the X-axis and the Y-axis. Each of the spray gun heads discharges ink. The Z-direction driver individually drives each spray gun head of the spray gun head unit based on setting data and measurement data related to a distance between the spray gun head and an object to which the ink is applied.

### CITATION LIST

### Patent Literature

### PTL 1

Japanese Unexamined Patent Application Publication No. H11-348258

### SUMMARY OF INVENTION

### Technical Problem

In the above-described automatic drawing apparatus, when the spay gun head is about to collide with a projection or the like of the object to which the ink is applied while drawing on the object, it is necessary to move the spray gun head unit away from the object to avoid the collision. At this time, if the entire spray gun head unit is moved away from the object, it takes a long time to move the spray gun head unit, and the above-described collision may be not avoided.

An object of the present disclosure is to provide a liquid discharge apparatus that can quickly move a liquid discharge head away from the object.

### Solution to Problem

Embodiments of the present disclosure describe an improved liquid discharge apparatus that includes a carriage, a liquid discharge head having a discharge port, a first driver, and a second driver. The carriage is movable along at least one of a first axis and a second axis intersecting the first axis. The liquid discharge head is held by the carriage and discharges a liquid from the discharge port toward an object in a direction along a third axis intersecting the first axis and the second axis. The first driver moves the carriage along the third axis. The second driver moves the liquid discharge head along the third axis relative to the carriage.

### Advantageous Effects of Invention

According to the present disclosure, the liquid discharge apparatus can be provided that can quickly move the liquid discharge head away from the object.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. In addition, identical or similar reference numerals designate identical or similar components throughout the several views.

FIGS. 1A and 1B are schematic views illustrating an overall configuration of a liquid discharge apparatus according to an embodiment of the present disclosure.

FIG. 2 is a perspective view of a carriage of the liquid discharge apparatus according to the present embodiment.

FIGS. 3A and 3B are perspective views of a wiper unit of the liquid discharge apparatus according to the present embodiment.

FIG. 4 is a perspective view of the carriage according to the present embodiment.

FIG. 5 is a perspective view of a Z-direction driver to move a head of the liquid discharge apparatus according to the present embodiment.

FIGS. 6A and 6B are schematic views for explaining a projection member of the carriage according to the present embodiment.

FIG. 7 is a schematic view for explaining a contact member of the head according to the present embodiment.

FIG. 8 is a block diagram of a portion related to movement control of the carriage.

FIG. 9 is a cross-sectional view of the head according to an embodiment of the present disclosure.

FIG. 10 is a schematic view of a liquid discharge apparatus according to a first variation of the present disclosure.

FIG. 11 is an enlarged perspective view of the liquid discharge apparatus according to the first variation.

FIG. 12 is a schematic perspective view of a liquid discharge apparatus according to a second variation of the present disclosure.

FIG. 13 is a schematic perspective view of a liquid discharge apparatus according to a third variation of the present disclosure.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the invention of this specification is not intended to be limited to the specific terminology so selected and it is to be understood that each specific element includes all technical equivalents that have a similar function, operate in a similar manner, and achieve a similar result.

It is to be noted that the suffixes Y, M, C, K, W, and S attached to each reference numeral indicate only that components indicated thereby are used for forming yellow, magenta, cyan, and black images, respectively, and hereinafter may be omitted when color discrimination is not necessary.

Embodiments of the present disclosure are described below with reference to the drawings.

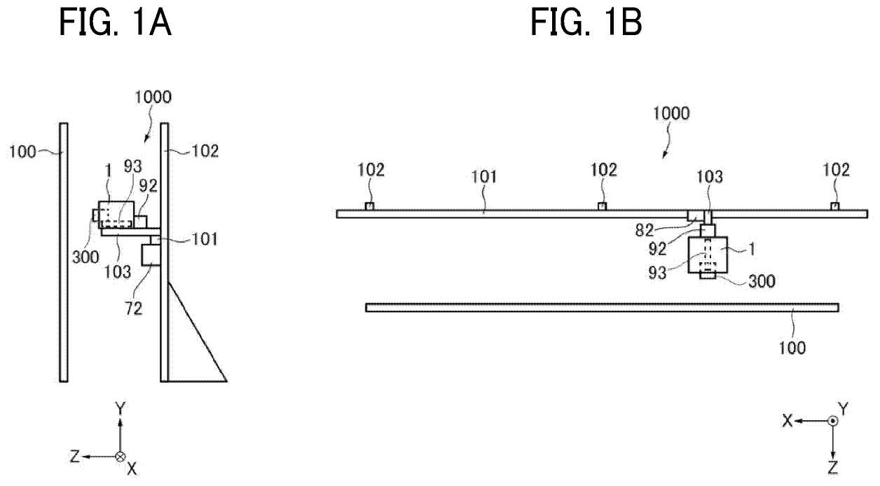

FIGS. 1A and 1B are schematic views illustrating an overall configuration of a liquid discharge apparatus 1000 according to an embodiment of the present disclosure. FIG. 1A is a side view, and FIG. 1B is a plan view of the liquid discharge apparatus 1000.

The liquid discharge apparatus 1000 is installed so as to face an object 100 on which images are drawn. The liquid discharge apparatus 1000 includes a carriage 1 on which a head 300 is mounted. The head 300 discharges ink, which is as an example of a liquid, toward the object 100. The carriage 1 is held by a Z-axis rail 103 and movable along a Z-axis. The head 300 is an example of a liquid discharge head.

The Z-axis rail 103 is held by an X-axis rail 101 and movable along an X-axis, and the X-axis rail 101 is held by a Y-axis rail 102 and movable along a Y-axis. Here, the X-axis is an example of a “first axis”, the Y-axis is an example of a “second axis intersecting the first axis”, and the Z-axis is an example of a “third axis intersecting the first axis and the second axis.” The carriage 1 is an example of a “liquid discharger.”

Further, the liquid discharge apparatus 1000 includes a first Z-direction driver 92 and an X-direction driver 72. The first Z-direction driver 92 moves the carriage 1 along the Z-axis along the Z-axis rail 103. The X-direction driver 72 moves the Z-axis rail 103 along the X-axis along the X-axis rail 101. The liquid discharge apparatus 1000 further includes a Y-direction driver 82 that moves the X-axis rail 101 along the Y-axis along the Y-axis rail 102. The first Z-direction driver 92 is an example of a “first driver” and moves the carriage 1 along the Z-axis intersecting the X-axis and the Y-axis.

The liquid discharge apparatus 1000 further includes a second Z-direction driver 93 mounted on the carriage 1. The second Z-direction driver 93 is an example of a “second driver” and moves the head 300 along the Z-axis relative to the carriage 1. In the present embodiment, the term “move along the third axis intersecting the first axis and the second axis” is not limited to the case in which the carriage 1 and the head 300 are moved parallel to the Z-axis. The term “move along the third axis intersecting the first axis and the second axis” also includes the case in which the carriage 1 and the head 300 are moved in an oblique direction including at least a Z-axis component.

The liquid discharge apparatus 1000 described above discharges ink from the head 300 toward the object 100 while moving the carriage 1 along the X-axis, the Y-axis, and the-Z axis, thereby drawing images on the object 100. Although the object 100 illustrated in FIGS. 1A and 1B has a flat plate shape, the object 100 may have a curved surface which is nearly vertical or a curved surface with the large radius of curvature, such as a surface of a car, a truck, or an aircraft.

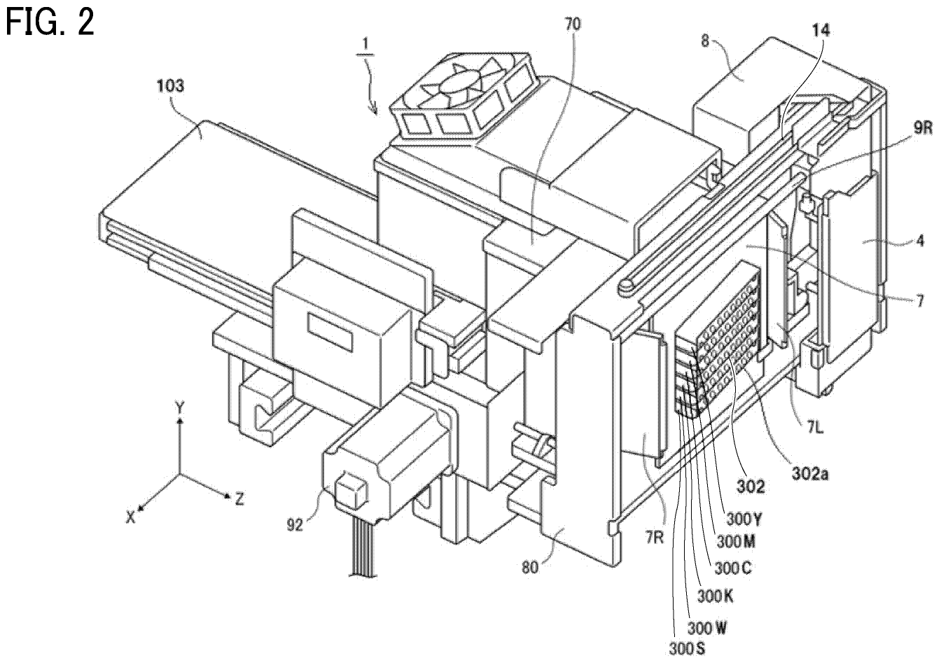

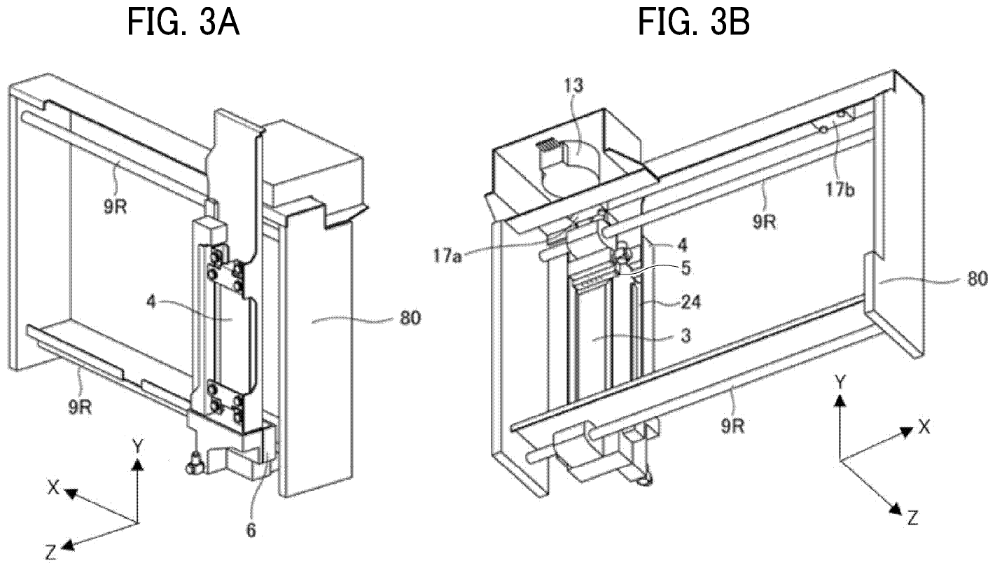

FIG. 2 is a perspective view of the carriage 1 according to the present embodiment.

The carriage 1 is movable along the Z-axis along the Z-axis rail 103 by driving force of the first Z-direction driver 92. The carriage 1 holds a head unit 70 including a head fixing plate 7 for attaching the head 300. In the present embodiment, a head 300Y for yellow, a head 300M for magenta, a head 300C for cyan, a head 300K for black, a head 300W for white, and a head 300S for spot color are attached to the head fixing plate 7. In the following description, these heads are also collectively referred to as “heads 300” for convenience of explanation. In addition to the head 300, the head unit 70 including the heads 300 also corresponds to an example of the “liquid discharge head.”

Each of the heads 300 includes a nozzle face 302a having a plurality of nozzles 302 thereon. The nozzle 302 is an example of a “discharge port”, and the nozzle face 302a is an example of a “liquid discharge surface.” Note that the types and number of colors of the inks used in the heads 300 are not limited to the above-described example. For example, all inks used in the heads 300 may be the same color.

The head 300 is secured to the head fixing plate 7 such that the nozzle face 302a intersects the horizontal plane and the plurality of nozzles 302 is obliquely arrayed with respect to the X-axis. Thus, the head 300 discharges ink from the nozzle 302 in a direction intersecting the direction of gravity.

Further, the carriage 1 includes a cleaning device to clean the head 300. In the present embodiment, a wiper unit 4 is an example of the cleaning device. The configuration of the wiper unit 4 is described below.

FIGS. 3A and 3B are perspective views of the wiper unit 4 according to the present embodiment. FIG. 3A is a perspective front view of the wiper unit 4, and FIG. 3B is a perspective rear view of the wiper unit 4.

As illustrated in FIG. 3A, the wiper unit 4 moves parallel to the X-axis along a pair of guide rails 9R secured to an upper portion and a lower portion of a frame 80. The wiper unit 4 includes an ink receiving surface 24, a wiper 3, and a cleaning liquid supplier 5 as illustrated in FIG. 3B, and further includes a cleaning liquid collector 6 as illustrated in FIG. 3A.

The cleaning liquid supplier 5 is connected to a cleaning liquid supply tube and supplies a cleaning liquid supplied through the cleaning liquid supply tube, to the wiper 3 and the ink receiving surface 24 from above in the downward direction (negative Y-axis direction). The cleaning liquid collector 6 is disposed below the wiper 3 and the ink receiving surface 24 (on the negative side along the Y-axis), and collects ink and the cleaning liquid that has cleaned the wiper 3 and the ink receiving surface 24. The cleaning liquid collector 6 is connected to a cleaning liquid collection tube, and the ink and the cleaning liquid accumulated in the cleaning liquid collector 6 are drained to the outside through the cleaning liquid collection tube.

As illustrated in FIG. 3B, a motor 13 is provided to move the wiper unit 4 along the X-axis, and sensors 17a and 17b are provided to detect the position of the wiper unit 4 on the X-axis. In the present embodiment, the sensor 17a detects that the wiper unit 4 is at a waiting position (home position), and the sensor 17b detects that the wiper unit 4 is at a moving end position (return position).

With the above configuration, the motor 13 transmits driving force to a belt 14 illustrated in FIG. 2 to move the wiper unit 4 coupled to the belt 14 along the X-axis along the guide rails 9R.

As the wiper unit 4 reaches a position facing the nozzle face 302a of the head 300, the wiper 3 comes into contact with the nozzle face 302a. Further, the ink receiving surface 24 can receive ink discharged from the nozzle 302 in a recovery operation of ink discharge of the nozzle 302 (head 300).

As the wiper unit 4 moves in the positive X-axis direction while the wiper unit 4 facing the nozzles 302, the wiper 3 wipes and cleans the nozzle face 302a and the nozzles 302.

As the wiper unit 4 further moves in the positive X-axis direction, the wiper 3 and the ink receiving surface 24 do not face the nozzle 302. After the wiper unit 4 reaches the moving end position, the movement direction of the wiper unit 4 is switched to the negative X-axis direction, and the wiper unit 4 returns to the waiting position.

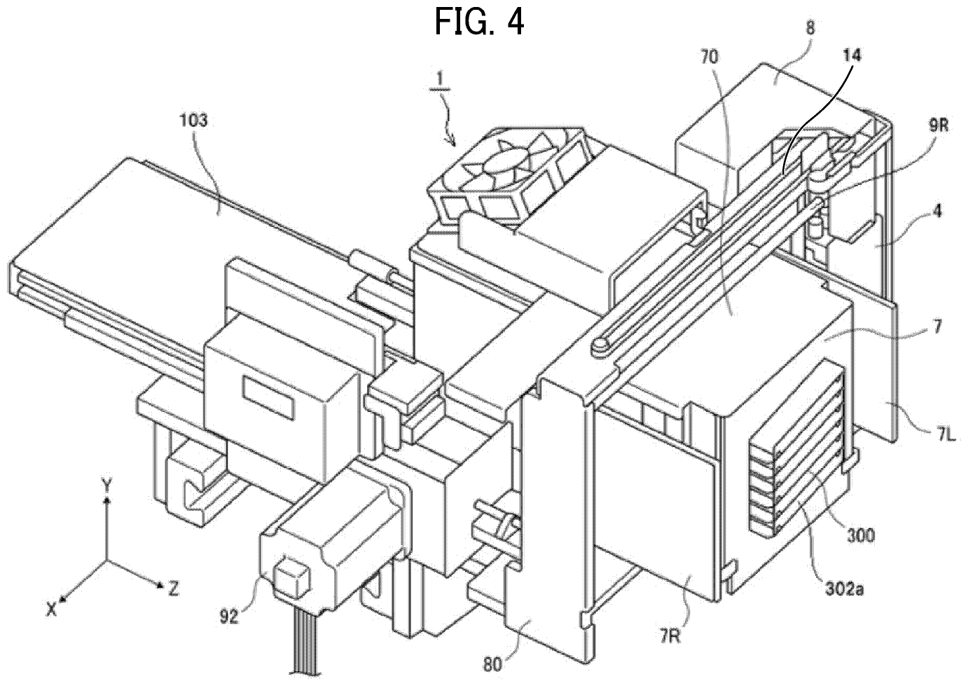

FIG. 4 is a perspective view of the carriage 1 according to the present embodiment. FIG. 4 illustrates a state in which the head 300 moves toward the object 100 in the positive Z-axis direction from a state illustrated in FIG. 2.

The head 300 moves along the Z-axis between an ink discharge position illustrated in FIG. 4 at which ink is discharged toward the object 100 and a standby position illustrated in FIG. 2 at which the head 300 is away from the object 100 compared with the ink discharge position. The first Z-direction driver 92 includes a drive motor to move the carriage 1 along the Z-axis. The second Z-direction driver 93 includes a power cylinder to move the head 300 along Z-axis relative to the carriage 1.

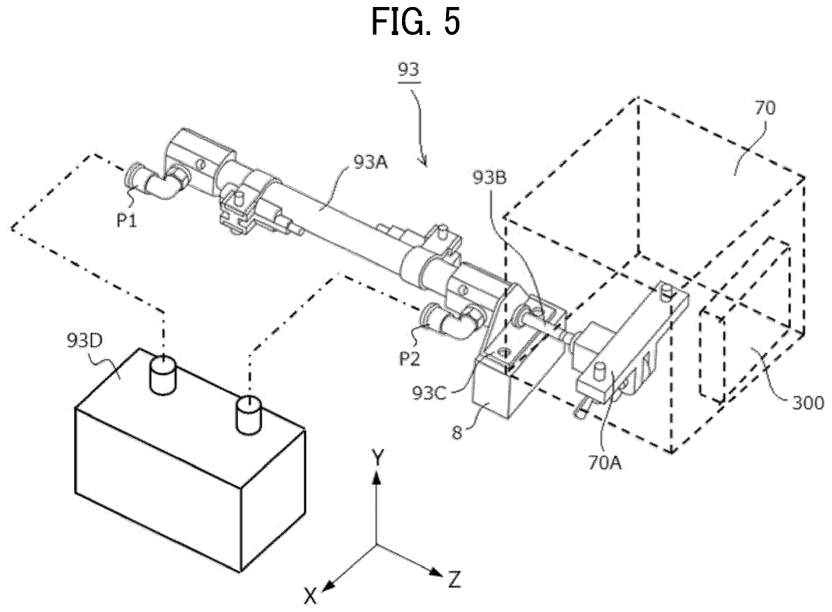

FIG. 5 is a perspective view of the second Z-direction driver 93 to move the head 300 along the Z-axis according to the present embodiment.

As described above, the second Z-direction driver 93 for driving the head unit 70 along the Z-axis relative to the carriage 1 includes the power cylinder. In the second Z-direction driver 93, various types of the power cylinders such as a pneumatic type, an oil hydraulic type, a water hydraulic type, and an electric type can be used.

In the present embodiment, a pneumatic cylinder (air cylinder) is used. The air cylinder illustrated in FIG. 5 is a double-acting air cylinder and has two ports P1 and P2 to which air pressure is applied. The port P1 and the port P2 are connected to an air solenoid valve 93D.

For example, when the air solenoid valve 93D is turned off, air is supplied to the port P1 and air is discharged from the port P2, and the second Z-direction driver 93 moves a piston 93B in the positive Z-axis direction in which the piston 93B is pushed out with respect to a cylinder body 93A.

Contrary to the above-description, when the air solenoid valve 93D is turned on, air is supplied to the port P2 and air is discharged from the port P1, and the second Z-direction driver 93 moves the piston 93B in the negative Z-axis direction in which the piston 93B is pulled into the cylinder body 93A.

Thus, the second Z-direction driver 93 turns on and off the air solenoid valve 93D to switch between the air supply and air discharge of the ports P1 and P2, thereby switching the operation direction of the piston 93B.

The cylinder body 93A includes an attachment portion 93C for attaching the cylinder body 93A to a housing 8 of the carriage 1. A support 70A that supports the head unit 70 holding the head 300 is provided at an end of the piston 93B.

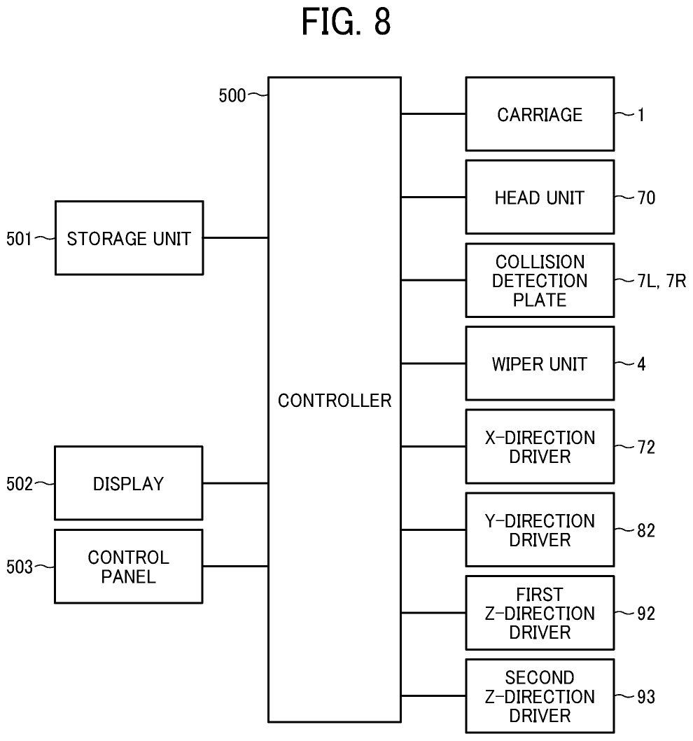

With the above-described configuration, the second Z-direction driver 93 moves the piston 93B back and forth along the Z-axis based on an instruction from a controller 500 (see FIG. 8). Thus, the head unit 70 moves along the Z-axis.

The second Z-direction driver 93 moves the head unit 70 along the Z-axis with a stroke length of about 75 mm at a moving speed of about 145 mm/s to 175 mm/s by the power cylinder. On the other hand, the first Z-direction driver 92 does not directly move the head unit 70 but moves the head unit 70 together with the carriage 1 along the Z-axis. As described above, the liquid discharge apparatus 1000 includes the first Z-direction driver 92 that moves the entire carriage 1 and the second Z-direction driver 93 that moves the head unit 70 relative to the carriage 1. Therefore, the first Z-direction driver 92 is not required to move the head unit 70 at a high speed, and thus, the second Z-direction driver 93 moves the head unit 70 along the Z-axis faster than the first Z-direction driver 92.

The driving source of the second Z-direction driver 93 is not limited to the power cylinder. The second Z-direction driver 93 may include other types of actuators, such as a drive motor, that can urgently retract the head 300 when an abnormality occurs.

As illustrated in FIG. 4, a left side wall plate 7L and a right side wall plate 7R, which are examples of the projection member, are disposed on the upstream side and the downstream side in the X-axis direction (on both sides along the X-axis) with respect to the nozzle face 302a of the head 300, respectively. Each of the left side wall plate 7L and the right side wall plate 7R is swingable around one end thereof supported by a shaft of carriage 1 parallel to the Y-axis.

The other end (distal end) of each of the left side wall plate 7L and the right side wall plate 7R projects to the same position as a surface position of the nozzle face 302a or to a position closer to the object 100 than the surface position of the nozzle face 302a along the Z-axis. The left side wall plate 7L and the right side wall plate 7R serves as collision detection plates that detect a collision object with which the head unit 70 is about to collide when the head 300 discharges ink to the object 100, and the operation thereof is described below.

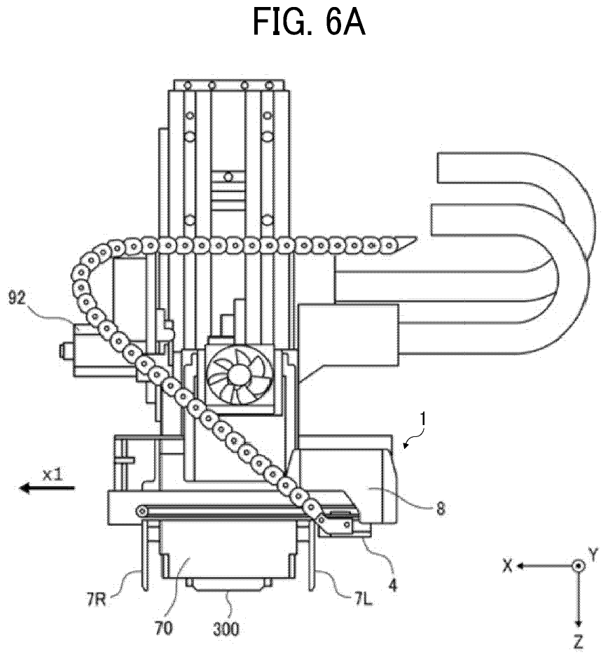

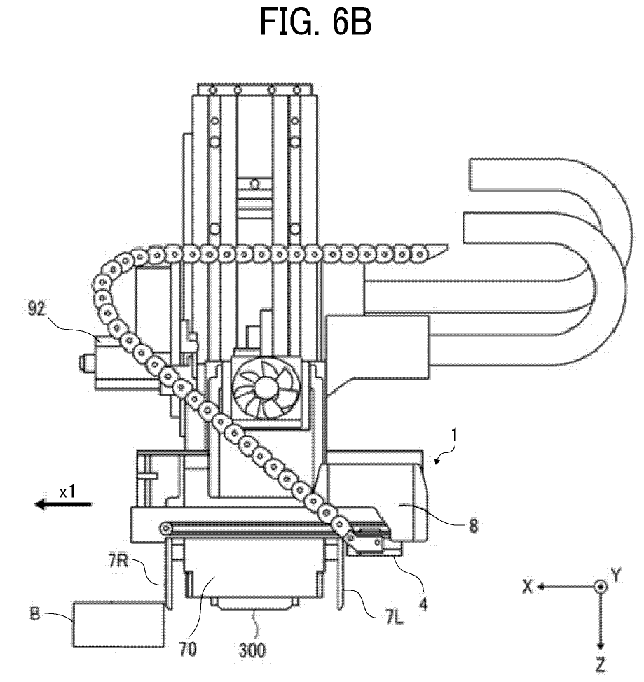

FIGS. 6A and 6B are schematic views for explaining the projection member according to the present embodiment. For example, when the carriage 1 moves in a direction indicated by arrow X1 as illustrated in FIG. 6A, if the right side wall plate 7R comes into contact with a collision object B as illustrated in FIG. 6B, the second Z-direction driver 93 described above operates based on an instruction from the controller 500 (see FIG. 8).

The second Z-direction driver 93 moves the head unit 70 together with the piston 93B in the negative Z-axis direction, thereby avoiding a collision between the head unit 70 and the collision object B. Similarly, when the carriage 1 moves in a direction opposite to the direction indicated by arrow X1 in FIG. 6A, if the left side wall plate 7L comes into contact with a collision object, the second Z-direction driver 93 also operates to move the head unit 70 in the negative Z-axis direction, thereby avoiding a collision between the head unit 70 and the collision object.

At the time of abnormality as described above, the second Z-direction driver 93 moves the head 300 together with the head unit 70 in the negative Z-axis direction. Therefore, as compared with the case in which the entire carriage 1 is moved, the weight of components to be moved can be reduced, and the head 300 can be quickly moved.

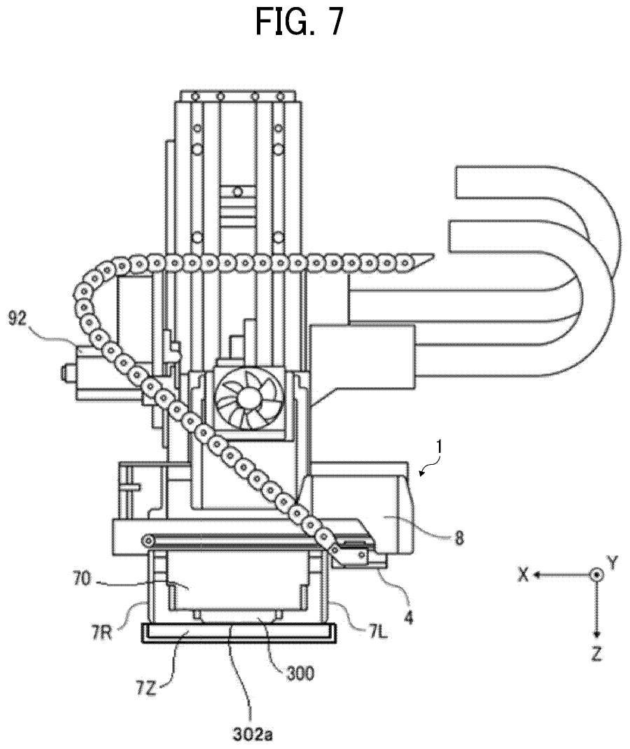

FIG. 7 is a schematic view for explaining a contact member 7Z according to the present embodiment. The head unit 70 includes the contact member 7Z in front of the nozzle face 302a of the head 300 along the Z-axis so that the contact member 7Z can contact the object 100.

The contact member 7Z is attached to the head unit 70. The contact member 7Z is temporarily positioned in front of the nozzle face 302a to measure a distance between the object 100 and the nozzle face 302a before the head 300 starts discharging ink to the object 100.

The head unit 70 to which the contact member 7Z is attached is connected to the controller 500 illustrated in FIG. 8 via the carriage 1, and the controller 500 causes the first Z-direction driver 92 to move the carriage 1 along the Z-axis so that the head unit 70 approaches the object 100. The controller 500 acquires data such as the movement amount and coordinate at the time when the contact member 7Z comes into contact with the surface of the object 100, and stores the data in a storage unit 501. The controller 500 repeats such an operation multiple times along the X-axis and Y-axis, and stores data of the surface shape of the object 100 in advance.

FIG. 8 is a block diagram of a portion related to movement control of the carriage 1 according to the present embodiment.

The liquid discharge apparatus 1000 includes the carriage 1, the head unit 70, the left and right side wall plates (collision detection plates) 7L and 7R, the wiper unit 4, the X-direction driver 72, the Y-direction driver 82, the first Z-direction driver 92, the second Z-direction driver 93, the controller 500, the storage unit 501, a display 502, and a control panel 503.

The carriage 1 is movable along the X-axis, Y-axis, and Z-axis with respect to the object 100, and includes the head unit 70, the left and right side wall plates (collision detection plates) 7L and 7R, the wiper unit 4, and the second Z-direction driver 93.

The head unit 70 is movable along the Z-axis relative to the carriage 1 and includes the head 300 that discharges ink toward the object 100.

When the liquid discharge apparatus 1000 performs the ink discharge of the head 300 or measures the position of the head unit 70 with respect to the object 100, the left and right side wall plates (collision detection plates) 7L and 7R detect a contact (collision) with a collision object to avoid a collision between the head unit 70 and the object 100. When detecting the contact (collision), the left and right side wall plates (collision detection plates) 7L and 7R transmit a detection signal indicating the contact (collision) to the controller 500.

The wiper unit 4 cleans the head 300 based on an instruction from the controller 500.

The X-direction driver 72 drives the carriage 1 along the X-axis based on an instruction from the controller 500.

The Y-direction driver 82 drives the carriage 1 along the Y-axis based on an instruction from the controller 500.

The first Z-direction driver 92 drives the carriage 1 along the Z-axis based on an instruction from the controller 500.

The second Z-direction driver 93 drives the head unit 70 along the Z-axis relative to the carriage 1 based on an instruction from the controller 500.

The controller 500 includes a central processing unit (CPU), a read-only memory (ROM), a random access memory (RAM), and an interface (I/F). The CPU controls the entire liquid discharge apparatus 1000. The ROM stores programs, which include a program to cause the CPU to perform the control of a drawing operation, for example, and other fixed data. The RAM temporarily stores drawing data including patterns and characters drawn on the object 100, body data such as the surface shape of the object 100, and the like. The I/F transmits data and signals that are used when the controller 500 receives drawing data and the like from a host such as a personal computer (PC).

The controller 500 causes the X-direction driver 72, the Y-direction driver 82, the first Z-direction driver 92, and the second Z-direction driver 93 to drive the carriage 1 and the head unit 70. In addition, the controller 500 causes the head 300 included in the head unit 70 to discharge ink and causes the wiper unit 4 to clean the nozzle face 302a of the head 300.

Further, when an abnormality occurs in the operations of the carriage 1, the head unit 70, and the head 300, the controller 500 displays information indicating the abnormality to a user on the display 502. The controller 500 receives an instruction from the control panel 503.

The storage unit 501 stores, for example, position data (three dimensional coordinates on the X, Y, and Z axes) indicating a position where the contact (collision) of the left and right side wall plates (collision detection plates) 7L and 7R occurs.

When an abnormality occurs in the liquid discharge apparatus 1000, the display 502 displays the information indicating the abnormality to the user.

The control panel 503 is used to input a value (coordinates) for specifying an area (drawing area) where ink is discharged onto the object 100, a moving speed of the carriage 1, drawing data and three dimensional coordinates (body data) used for drawing on the object 100, a distance between the head 300 and the object 100, and the like. Note that the display 502 and the control panel 503 may be combined into one screen with a touch panel or the like.

Next, the configuration of the head 300 is described in detail.

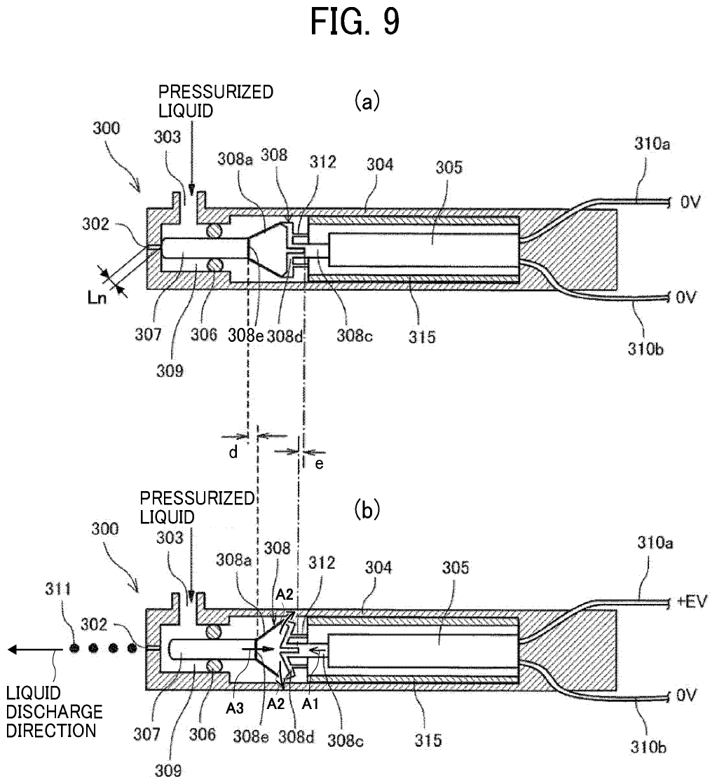

FIG. 9 is a schematic cross-sectional view of one nozzle part of the head 300 according to the present embodiment. A part (a) of FIG. 9 illustrates a state in which the nozzle 302 is closed, and a part (b) of FIG. 9 illustrates a state in which the nozzle 302 is opened.

The head 300 includes a hollow housing 304 including the nozzle 302 at a distal end of the head 300 to discharge a liquid. The housing 304 includes an injection port 303 near the nozzle 302, and the liquid is injected inside the housing 304 from the injection port 303. The head 300 includes a piezoelectric element 305, a valve 307, and a valve mover 308 in the housing 304. The piezoelectric element 305 expands and contracts in response to an externally applied voltage. The valve 307 opens and closes the nozzle 302. The valve mover 308 is disposed between the valve 307 and the piezoelectric element 305. The valve mover 308 moves the valve 307 toward or away from the nozzle 302.

The piezoelectric element 305 is housed in a case 315, and a pair of wirings 310a and 310b to apply a voltage to the piezoelectric element 305 are drawn outside the housing 304. The piezoelectric element 305 drives the valve 307 via the valve mover 308.

A sealing 306 is disposed between the valve 307 and the housing 304 to prevent the pressurized liquid injected from the injection port 303 from entering the piezoelectric element 305 side of the housing 304, thereby forming a liquid chamber 309. The housing 304 has a cylindrical body such as a cylinder or a square tube and has an enclosed space that is closed except for the nozzle 302 and the injection port 303.

The nozzle 302 is an opening having a length Ln and formed at the distal end of the housing 304, and ink 311 is discharged from the nozzle 302. That is, in the present embodiment, the liquid (ink 311) is discharged in a liquid discharge direction along the longitudinal axis of the nozzle 302 as illustrated in the part (b) of FIG. 9.

The injection port 303 is formed on a side surface of the housing 304 near the nozzle 302. The pressurized liquid is continuously supplied to the injection port 303.

The piezoelectric element 305 is an element using zirconia ceramics or the like. A drive waveform (drive voltage) is applied to the piezoelectric element 305 via the wirings 310a and 310b. The sealing 306 is, for example, a packing, an O-ring, or the like. The sealing 306 externally fitted on the valve 307 can prevent a liquid from flowing into the piezoelectric element 305 side from the injection port 303 side of the housing 304.

The valve mover 308 includes a deformable part 308a having a substantially trapezoidal cross-section formed of a resiliently deformable elastic member, such as rubber, soft resin, a thin metal plate, or the like. A coupling portion 308e corresponding to a top side of the substantially trapezoidal cross-section of the deformable part 308a is secured to a base end surface of the valve 307. A long side corresponding to a bottom of the substantially trapezoidal cross-section of the deformable part 308a is coupled to a bent side 308d. A center portion of the bent side 308d in the radial direction is coupled to a guide part 308c, and a part between the center portion and an end portion in the radial direction of the bent side 308d is coupled to a fixed part 312. One end of the fixed part 312 is coupled to the case 315.

When a predetermined voltage is applied to the piezoelectric element 305, the piezoelectric element 305 expands to move the valve mover 308 so that the guide part 308c moves toward the nozzle 302 by a distance “e”, for example, as illustrated in the part (b) of FIG. 9. Thus, a vicinity of the center portion of the bent side 308d is pushed into the valve mover 308 as indicated by arrow A1 in the part (b) of FIG. 9.

Then, the bent side 308d is displaced in the direction indicated by arrows A2 in the part (b) of FIG. 9 from a coupling portion with the fixed part 312 as a starting point of displacement because the bent side 308d is coupled to the fixed part 312 on an outer peripheral side of the guide part 308c. When the bent side 308d is displaced in the direction indicated by arrows A2 in the part (b) of FIG. 9, the deformable part 308a is deformed so that a coupling portion 308e with the valve 307 is pulled in the direction indicated by arrow A3 in the part (b) of FIG. 9.

As the deformable part 308a of the valve mover 308 is deformed, the valve 307 secured to the coupling portion 308e of the deformable part 308a is retracted by a distance “d”, thereby opening the nozzle 302. That is, the guide part 308c moves toward the nozzle 302 by the distance “e” due to an expansion of the piezoelectric element 305, so that the valve 307 moves by the distance “d” in the direction (rightward) opposite a moving direction (leftward or the direction of expansion of the piezoelectric element 305) of the guide part 308c.

Here, a distance between the coupling portion 308e and the bent side 308d or a length of the bent side 308d is adjusted to increase a moving amount of the valve 307 to be longer than a displacement amount of the piezoelectric element 305. The valve 307 is secured to the deformable part 308a of the valve mover 308 at the coupling portion 308e as described above. That is, the valve mover 308 can amplify the displacement of the piezoelectric element 305 and reduce the displacement of the piezoelectric element 305, so that the size of the piezoelectric element 305 can be downsized.

Hereinafter, a first variation based on the present disclosure is described.

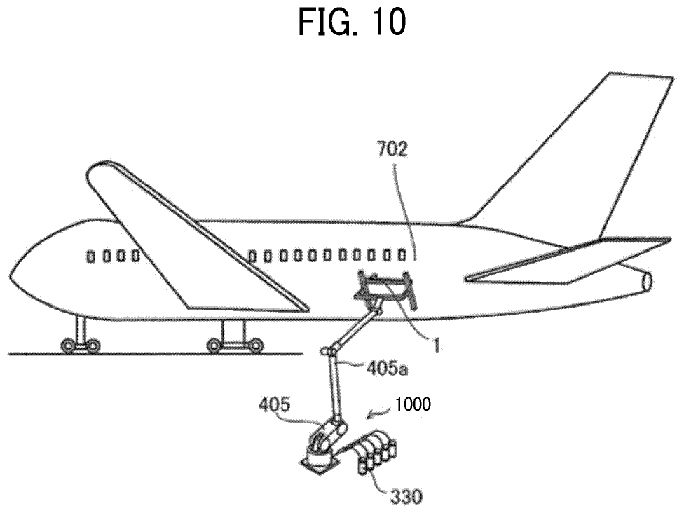

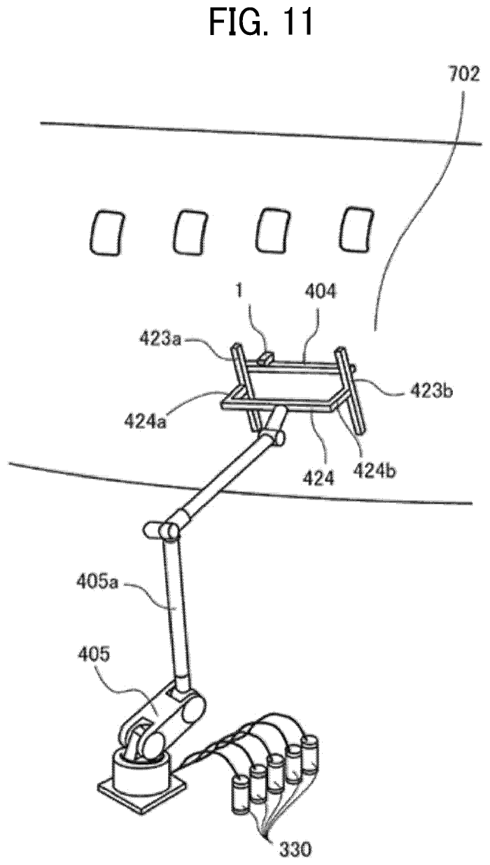

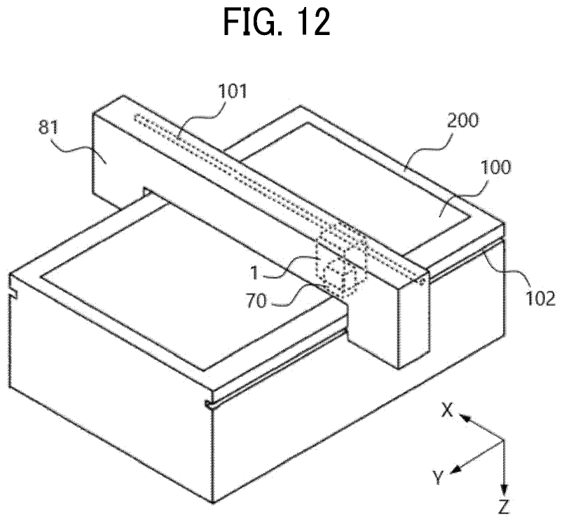

FIG. 10 is a schematic view of a liquid discharge apparatus 1000 according to the first variation of the present disclosure. FIG. 11 is an enlarged perspective view of the liquid discharge apparatus 1000 according to the first variation.

The liquid discharge apparatus 1000 includes a linear rail 404 and a multi-articulated robot 405. The linear rail 404 guides the carriage 1 that reciprocally and linearly moves along the linear rail 404. The multi-articulated robot 405 appropriately moves the linear rail 404 to a predetermined position and holds the linear rail 404 at the predetermined position.

The multi-articulated robot 405 includes a robot arm 405a that is freely movable like a human arm by a plurality of joints. The multi-articulated robot 405 can freely move a distal end of the robot arm 405a and arrange the distal end of the robot arm 405a at an accurate position.

An industrial robot of a six-axis control-type having six axes (six joints) can be used as the multi-articulated robot 405, for example. According to the multi-articulated robot 405 of the six-axis control-type, it is possible to previously teach data related to a movement of the multi-articulated robot 405. As a result, the multi-articulated robot 405 can accurately and quickly position the linear rail 404 at a predetermined position facing a target object 702 (aircraft). The number of axes of the multi-articulated robot 405 is not limited to six, and a multi-articulated robot having an appropriate number of axes such as five axes or seven axes can be used.

The robot arm 405a of the multi-articulated robot 405 includes a fork-shaped support 424 bifurcated into two. A vertical linear rail 423a is attached to a tip of a left branch 424a of the support 424, and a vertical linear rail 423b is attached to a tip of a right branch 424b of the support 424. The vertical linear rail 423a and the vertical linear rail 423b are parallel to each other.

Further, both ends of the linear rail 404 that movably holds the carriage 1 are supported by the vertical linear rails 423a and 423b to bridge between two of the vertical linear rails 423a and 423b.

The carriage 1 has the configuration in the embodiment described with reference to FIG. 2 and the like, and includes a head that discharges a liquid toward the target object 702. The carriage 1 includes, for example, the head 300 described with reference to FIG. 2 and the like, a plurality of heads 300 that discharges liquids of respective colors (e.g., yellow, magenta, cyan, black, and white), or a head 300 having a plurality of nozzle rows. The liquids of respective colors are respectively supplied from ink tanks 330 to the heads 300 or the nozzle rows of the head 300 of the carriage 1.

The carriage 1 moves on the linear rail 404 along the first axis. As the linear rail 404 moves on the vertical linear rails 423a and 423b, the carriage 1 moves along the second axis intersecting the first axis.

The carriage 1 includes a first driver that moves the carriage 1 along the third axis intersecting the first axis and the second axis. In the first variation, the head 300 discharges a liquid to the target object 702 in the liquid discharge direction along the third axis. The carriage 1 further includes the second driver that moves the head 300 along the third axis relative to the carriage 1.

In the liquid discharge apparatus 1000, the multi-articulated robot 405 moves the linear rail 404 to a desired drawing area of the target object 702, and the heads 300 are driven to draw images on the target object 702 while moving the carriage 1 along the linear rail 404 according to drawing data.

When the liquid discharge apparatus 1000 ends drawing of one line, the liquid discharge apparatus 1000 causes the vertical linear rails 423a and 423b of the multi-articulated robot 405 to move the heads 300 of the carriage 1 from the one line to the next line.

The liquid discharge apparatus 1000 repeats the above-described operation to draw images on the desired drawing area of the target object 702.

During the drawing operation, the carriage 1 including the wiper unit 4 can wipe and clean the nozzle face 302a of the head 300 at any time although a moving distance of the carriage 1 (head 300) increases.

In the first variation, the wiper unit 4 wipes the nozzle 302 before and after the drawing operation of one line. Thus, the liquid discharge apparatus 1000 can continuously draw high quality images with small downtime.

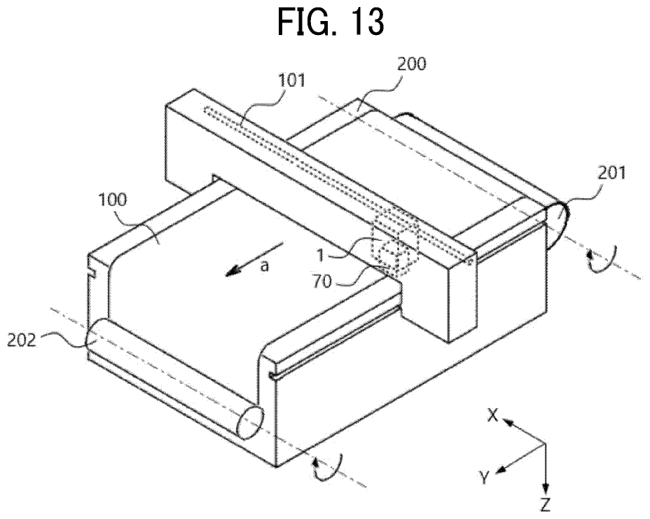

FIG. 12 is a schematic perspective view of a liquid discharge apparatus according to a second variation of the present disclosure.

In the liquid discharge apparatus according to the second variation, the carriage 1 including the head unit 70 moves along the X-axis and the Y-axis with respect to the object 100 to draw images on the object 100. The object, such as paper, film, wood plate, or the like is positioned on a horizontal table 200.

The carriage 1 moves along the X-axis (an example of the first axis) along the X-axis rail 101. In addition, as a frame 81 supporting the X-axis rail 101 moves along the Y-axis rail 102 disposed on the side surface of the table 200, the carriage 1 moves along the Y-axis (an example of the second axis).

Similarly to the above-described embodiments, the head unit 70 includes a head, and a head surface of the head is movable along the Z-axis (an example of the third axis).

Also in the second variation, the carriage 1 includes the first driver that moves the carriage 1 along the Z-axis and the second driver that moves the head unit 70 along the Z-axis relative to the carriage 1.

The liquid discharge apparatus according to the second variation is different from the above-described embodiments in that a liquid is discharged downward in the direction of gravity to the object 100 horizontally placed on the table 200. The present disclosure is applicable to such a liquid discharge apparatus.

FIG. 13 is a schematic perspective view of a liquid discharge apparatus according to a third variation of the present disclosure.

The liquid discharge apparatus according to the third variation is different from the liquid discharge apparatus according to the second variation in that the object 100 is conveyed on the table 200 in the direction indicated by arrow a. In the liquid discharge apparatus according to the third variation, the carriage 1 including the head unit 70 moves along the X-axis (an example of the first axis) to draw images on the object 100. The object 100 is fed from an object feeder 201. As the carriage 1 ends drawing of one line, the object 100 is conveyed by a predetermined length. Then, the carriage 1 draws the next line while moving along the X-axis.

Similarly to the liquid discharge apparatus according to the second variation, the carriage 1 moves along the X-axis along the X-axis rail 101. The liquid discharge apparatus according to the third variation is different from the liquid discharge apparatus according to the second variation in which the carriage 1 also moves along the Y-axis. In the third variation, since the object 100 is conveyed on the table 200, the carriage 1 is not required to move along the Y-axis (an example of the second axis) while drawing on the object 100, and is secured (stopped) at a predetermined position.

The object 100 that has passed under the carriage 1 is wound by an object winder 202. Also in the third variation, similarly to the above-described embodiments, the head unit 70 includes a head, and a head surface of the head is movable along the Z-axis (an example of the third axis).

Also in the third variation, the carriage 1 includes the first driver that moves the carriage 1 along the Z-axis and the second driver that moves the head unit 70 along the Z-axis relative to the carriage 1.

The liquid discharge apparatus according to the third variation is different from the above-described embodiments in that the carriage 1 moves only along the X-axis and the Z-axis and does not move along the Y-axis because the object 100 is conveyed along the Y-axis. The present disclosure is applicable to such a liquid discharge apparatus.

As described above, the liquid discharge apparatus 1000 according to the above embodiments of the present disclosure includes the head 300 (an example of a liquid discharge head) having the nozzle 302 (an example of a discharge port), the carriage 1 (an example of a liquid discharger), the first Z-direction driver 92 (an example of a first driver), and the second Z-direction driver 93 (an example of a second driver). The head 300 discharges ink (an example of a liquid) from the nozzle 302 toward the object 100 (an example of an object) in a direction along the Z-axis (an example of a third axis) intersecting the X-axis (an example of a first axis) and the Y-axis (an example of a second axis). The carriage 1 holds the head 300. The carriage 1 is movable along at least one of the X-axis and the Y-axis intersecting the X-axis. The first Z-direction driver 92 moves the carriage 1 along the Z-axis. The second Z-direction driver 93 moves the head 300 along the Z-axis relative to the carriage 1.

Accordingly, the head 300 can be quickly moved in a direction away from the object 100.

In the liquid discharge apparatus 1000, the second Z-direction driver 93 moves the nozzle face 302a (head 300) along the Z-axis faster than the first Z-direction driver 92.

Accordingly, the nozzle face 302a can be quickly moved relative to the carriage 1.

In the liquid discharge apparatus 1000, the first Z-direction driver 92 includes a drive motor.

Accordingly, the first Z-direction driver 92 can be controlled so as to finely move the carriage 1 and align the nozzle face 302a together with the carriage 1 with respect to the object 100 with high accuracy.

In the liquid discharge apparatus 1000, the second Z-direction driver 93 includes a power cylinder.

Accordingly, when the nozzle 302 and the nozzle face 302a need to be cleaned or when urgency is required, the second Z-direction driver 93 can quickly retract the nozzle face 302a from the object 100.

In the liquid discharge apparatus 1000, the head 300 includes the nozzle face 302a (an example of a liquid discharge surface) on which the nozzle 302 is formed. The second Z-direction driver 93 moves the nozzle face 302a relative to the carriage 1 along the Z-axis between an ink discharge position (liquid discharge position) at which the head 300 discharges the ink to the object 100 and a standby position at which the carriage 1 is away from the object 100 compared with the ink discharge position. The carriage 1 includes the wiper unit 4 (an example of a cleaning device) that cleans the nozzle face 302a at the standby position.

Accordingly, when the nozzle face 302a needs to be cleaned (wiping, dummy discharge, or the like), the nozzle face 302a can be quickly moved from the ink discharge position to the standby position, and the time until the start of cleaning can be shortened.

In the liquid discharge apparatus 1000, the head 300 includes the nozzle face 302a on which the nozzle 302 is formed. The second Z-direction driver 93 moves the nozzle face 302a relative to the carriage 1 along the Z-axis between the ink discharge position at which the head 300 discharges the ink to the object 100 and the standby position at which the carriage 1 is away from the object 100 compared with the ink discharge position. The carriage 1 includes the left side wall plate 7L and the right side wall plate 7R (examples of projection member) on both sides of the nozzle face 302a along the X-axis. Each of the left side wall plate 7L and the right side wall plate 7R has a distal end projecting to the same position as the nozzle face 302a or a position closer to the object 100 than the nozzle face 302a along the Z-axis.

Accordingly, when the left side wall plate 7L or the right side wall plate 7R comes into contact with the collision object B, the nozzle face 302a can be quickly moved from the ink discharge position to the standby position, thereby avoiding the collision with the collision object B.

In the liquid discharge apparatus 1000, the head 300 includes the nozzle face 302a on which the nozzle 302 is formed and the contact member 7Z (an example of a contact member). The contact member contacts the object 100 in front of the nozzle face 302a along the Z axis. The first Z-direction driver 92 moves the nozzle face 302a in a direction toward the object 100 and in a direction away from the object 100 along the Z-axis.

Accordingly, before starting to draw on the object 100, the liquid discharge apparatus 1000 can acquire data related to the surface shape of the object 100.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application Nos. 2020-130178, filed on Jul. 31, 2020 and 2021-073082, filed on Apr. 23, 2021, in the Japan Patent Office, the entire disclosure of each of which is hereby incorporated by reference herein.

### REFERENCE SIGNS LIST

1000 Liquid discharge apparatus

1 Carriage (an example of a liquid discharger)

3 Wiper

4 Wiper unit (an example of a cleaning device)

5 Cleaning liquid supplier

6 Cleaning liquid collector

7 Head fixing plate

7L Left side wall plate (an example of a projection member)

7R Right side wall plate (an example of a projection member)

7Z Contact member

8 Housing

14 Belt

24 Ink receiving surface

70 Head unit (an example of a liquid discharge head)

80 Frame

92 First Z-direction driver (an example of a first driver)

93 Second Z-direction driver (an example of a second driver)

100 Object

101 X-axis rail

102 Y-axis rail

103 Z-axis rail

300 Head (an example of a liquid discharge head)

302 Nozzle (an example of a discharge port)

302a Nozzle face (an example of a liquid discharge surface)

330 Ink tank

1. A liquid discharge apparatus comprising:
a carriage which is movable along at least one of a first axis and a second axis intersecting the first axis;
a liquid discharge head having a discharge port, the liquid discharge head held by the carriage and to discharge a liquid from the discharge port toward an object in a direction along a third axis intersecting the first axis and the second axis;
a first driver to move the carriage holding the liquid discharge head along the third axis; and
a second driver to move the liquid discharge head along the third axis relative to the carriage.

2. The liquid discharge apparatus according to claim 1,
wherein the second driver moves the liquid discharge head along the third axis faster than the first driver.

3. The liquid discharge apparatus according to claim 1,
wherein the first driver includes a drive motor.

4. The liquid discharge apparatus according to claim 1,
wherein the second driver includes a power cylinder.

5. The liquid discharge apparatus according to claim 1,
wherein the liquid discharge head includes a liquid discharge surface having the discharge port thereon,
wherein the second driver is to move the liquid discharge surface relative to the carriage along the third axis between a liquid discharge position at which the liquid discharge head discharges the liquid to the object and a standby position at which the carriage is away from the object compared with the liquid discharge position, and
wherein the carriage includes a cleaner to clean the liquid discharge surface at the standby position.

6. The liquid discharge apparatus according to claim 1,
wherein the liquid discharge head includes a liquid discharge surface having the discharge port thereon,
wherein the second driver is to move the liquid discharge surface relative to the carriage along the third axis between a liquid discharge position at which the liquid discharge head discharges the liquid to the object and a standby position at which the carriage is away from the object compared with the liquid discharge position, and
wherein the carriage includes projections on both sides of the liquid discharge surface along at least one of the first axis and the second axis, each of the projections having a distal end projecting to the same position as the liquid discharge surface or a position closer to the object than the liquid discharge surface along the third axis.

7. The liquid discharge apparatus according to claim 1, wherein the liquid discharge head includes:
a liquid discharge surface having the discharge port thereon; and
a contact in front of the liquid discharge surface along the third axis, the contact to contact the object, and
wherein the first driver is to move the liquid discharge surface in a direction toward the object and in a direction away from the object along the third axis.

8. A liquid discharger comprising:
a carriage which is movable along at least one of a first axis and a second axis intersecting the first axis, and which is movable along a third axis intersecting the first axis and the second axis by a first driver;
a liquid discharge head having a discharge port, the liquid discharge head held by the carriage and to discharge a liquid from the discharge port toward an object in a direction along the third axis; and
a second driver to move the liquid discharge head along the third axis relative to the carriage.

9. A method for driving a liquid discharge head held by a liquid discharger, the liquid discharger being movable along at least one of a first axis and a second axis intersecting the first axis and the liquid discharge head to discharge a liquid from a discharge port toward an object in a direction along a third axis intersecting the first axis and the second axis, the method comprising:
moving the liquid discharger along the third axis; and
moving the liquid discharge head along the third axis relative to the liquid discharger.
